(19) United States
(12) Patent Application Publication
(10) Pub. No.: US 2024/0428301 A1
(43) Pub. Date: Dec. 26, 2024

(54) INFORMATION PROCESSING DEVICE

(71) Applicant: TOYOTA JIDOSHA KABUSHIKI KAISHA, Toyota-shi (JP)

(72) Inventor: Atsushi HIGAKI, Nishi-Tokyo City (JP)

(73) Assignee: TOYOTA JIDOSHA KABUSHIKI KAISHA, Toyota-shi (JP)

(21) Appl. No.: 18/443,703

(22) Filed: Feb. 16, 2024

(30) Foreign Application Priority Data
Jun. 23, 2023 (JP) 2023-103127

(51) Int. Cl. G06Q 30/0283; G06Q 30/02; G06Q 40/03

(52) U.S. Cl. CPC G06Q 30/0283; G06Q 30/0278; G06Q 40/03

(57) ABSTRACT

In the information processing device, the control unit: receives input of information including a remaining price of the first vehicle at a first time, a remaining price thereof at a second time, a predetermined cost, a remaining bond of the first vehicle at the first time, a remaining bond of the first vehicle at the second time, a monthly insurance premium of the first vehicle, and a vehicle type of the second vehicle; calculates, based on the received information, a first payment amount in a case where it is assumed that the vehicle is transferred from the first vehicle to the second vehicle at the first time, and a second payment amount in a case where it is assumed that the vehicle is transferred from the first vehicle to the second vehicle at the second time; and outputs information for comparing the first payment amount and the second payment amount.

### CROSS-REFERENCE TO RELATED APPLICATION

This application claims priority to Japanese Patent Application No. 2023-103127 filed on Jun. 23, 2023, incorporated herein by reference in its entirety.

### BACKGROUND

### 1. Technical Field

The present disclosure relates to an information processing device.

### 2. Description of Related Art

A technique for promoting sales of a vehicle is known (see, for example, Japanese Unexamined Patent Application Publication No. 2005-227977 (JP 2005-227977 A)).

### SUMMARY

An object of the present disclosure is to provide a technique that is effective in promoting a user to replace his/her vehicle.

One aspect of the present disclosure provides an information processing device. In that case, the information processing device includes, for example, a control unit configured to execute:
receiving input of information including a residual value of a first vehicle used by a user at a first timing, a residual value of the first vehicle at a future second timing that is later than the first timing, a predetermined cost to be incurred when it is assumed that the first vehicle is continuously used from the first timing to the second timing, a remaining loan balance for the first vehicle at the first timing, a remaining loan balance for the first vehicle at the second timing, a monthly insurance premium for the first vehicle, and a vehicle type of a second vehicle with which the user wishes to replace his/her vehicle;
calculating, in response to the receiving of the input, a first payment amount to be paid when it is assumed that the first vehicle is replaced with the second vehicle at the first timing and a second payment amount to be paid when it is assumed that the first vehicle is replaced with the second vehicle at the second timing; and
outputting information on a comparison between the first payment amount and the second payment amount.

The present disclosure can also be regarded as an information processing method in which a computer executes processing of the information processing device. The present disclosure can also be regarded as an information processing program for causing a computer to execute the information processing method or a non-transitory storage medium storing the information processing program.

According to the present disclosure, it is possible to provide a technique that is effective in promoting a user to replace his/her vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating a configuration example of a system according to an embodiment;

FIG. 2 is a diagram illustrating a first exemplary supporting Web;

FIG. 3 is a diagram illustrating a second embodiment of a supporting Web page; and

FIG. 4 is a flowchart illustrating a flow executed by servers in the embodiment.

### DETAILED DESCRIPTION OF EMBODIMENTS

In a sales service or a leasing service of a vehicle, there is a so-called transfer in which a vehicle (first vehicle) currently used by a user is taken out and another vehicle (second vehicle) is purchased or leased. Meanwhile, the trade-in price of the first vehicle tends to decrease with time. Therefore, in a case where the user uses the first vehicle in an installment, the remaining bonds become larger than the trade-in price of the first vehicle depending on the time of the transfer. In such a case, the user needs to pay the remaining debt of the first vehicle in addition to the payment amount of the second vehicle. Therefore, it is necessary to raise the user's willingness to change at a timing when the trade-in price of the first vehicle exceeds the remaining bonds.

Therefore, in the information processing device according to the present disclosure, the control unit receives the input of information including the remaining price of the first vehicle at the first time of the first vehicle used by the user, the remaining price of the first vehicle at a second time later than the first time, the predetermined cost that occurs when it is assumed that the first vehicle is continuously used from the first time to the second time, the remaining bond of the first vehicle at the first time, the remaining bond of the first vehicle at the second time, the monthly insurance premium of the first vehicle, and the vehicle type of the second vehicle that the user desires to transfer. In this case, the control unit may output a user interface screen including an input field of the remaining price of the first vehicle at the first time, an input field of the remaining price of the first vehicle at the second time, an input field of the predetermined cost, an input field of the remaining bond of the first vehicle at the first time, an input field of the remaining bond of the first vehicle at the second time, an input field of the monthly insurance premium of the first vehicle, and an input field of the vehicle type of the second vehicle.

Here, the first timing is a timing when the trade-in price of the first vehicle exceeds the remaining debt of the first vehicle. As an example, the first timing may be a timing at which the user visits a predetermined base in a period in which the trade-in price of the first vehicle exceeds the remaining bonds of the first vehicle. The predetermined base is, for example, a store (for example, a car dealer or the like) of a business operator that provides a sales service and/or a lease service of a vehicle or a maintenance factory operated by a business operator or the like commissioned by the business operator. Further, the second time is a time in the future from the first time, and is a time at which the user easily considers the transfer (for example, a time at which the first vehicle is legally inspected or the vehicle is inspected).

Upon receiving the input of the above-described information, the control unit calculates the first payment amount and the second payment amount. The first payment amount is a payment amount of the user assuming that the first vehicle is transferred to the second vehicle at the first time. The second payment amount is a payment amount of the user assuming that the first vehicle is replaced with the second vehicle at the second time.

As an example, the first payment amount may be calculated by the following procedure.
(1) The number of months from the 1 time to the 2 time is multiplied by the monthly insurance premium of the 1 vehicle, and the 1 amount is calculated
(2) The second amount of money is calculated by adding a first amount of money and predetermined expense to the residual price of the first vehicles in a first time
(3) The remaining debt of the first vehicles in a first time is subtracted from the second amount of money, and the 3rd amount of money is calculated
(4) The 3 amount of money is subtracted from the amount of payment for the 2 vehicle to calculate the 1 amount of payment

Further, as an example, the second payment amount may be calculated by the following procedure.
(5) The balance of the first vehicles in a second time is subtracted from the balance of the first vehicles in a second time, and the 4th amount of money is calculated
(6) The 4 amount of money is subtracted from the amount of payment for the 2 vehicle to calculate the 2 amount of payment

Here, the predetermined cost includes, for example, a cost of maintenance (for example, statutory inspection and/or vehicle maintenance) that the first vehicle needs to receive during a period from the first time period to the second time period, and a tax imposed on the first vehicle during a period from the first time period to the second time period.

In the calculation of the first payment amount and the second payment amount, the first amount and the predetermined cost may be used for the calculation of the second payment amount instead of being used for the calculation of the first payment amount. In this case, the amount obtained by subtracting the remaining bond of the first vehicle in the first period from the remaining price of the first vehicle in the first period may be set as the third amount (in this case, the calculation of the second amount is unnecessary). Accordingly, the amount obtained by subtracting the remaining bond of the first vehicle and the predetermined cost in the second period from the remaining price of the first vehicle in the second period may be set as the fourth amount.

When the first payment amount and the second payment amount are calculated in the above-described procedure, the control unit outputs information for comparing the calculated first payment amount and the calculated second payment amount. Here, when the information processing device according to the present disclosure is a terminal used by a selling service of a vehicle and/or an operator providing a leasing service, outputting information comparing the first payment amount and the second payment amount may include outputting a user interface screen including information comparing the first payment amount and the second payment amount. Further, when the information processing device according to the present disclosure is a Web server connected to the terminal of the business operator through a network, outputting information comparing the first payment amount and the second payment amount may include causing a user interface screen (Web page) including information comparing the first payment amount and the second payment amount to be output to a browser of the terminal.

According to the information processing device of the present disclosure, the business operator can appeal to the user that the transfer at the first time is more expensive than the transfer at the second time (the financial burden of the user is less). In this way, it is possible to promote the transfer of the user.

Hereinafter, an embodiment of the present disclosure will be described with reference to the drawings. The hardware configuration, the module configuration, the functional configuration, and the like described in the following embodiments are not intended to limit the technical scope of the disclosure only thereto unless otherwise specified.

### Embodiment

Embodiments of the present disclosure will be described with reference to the drawings. In the present embodiment, an example in which the information processing device according to the present disclosure is applied to a system that provides a sales service and a lease service of a vehicle will be described.

### System Configuration

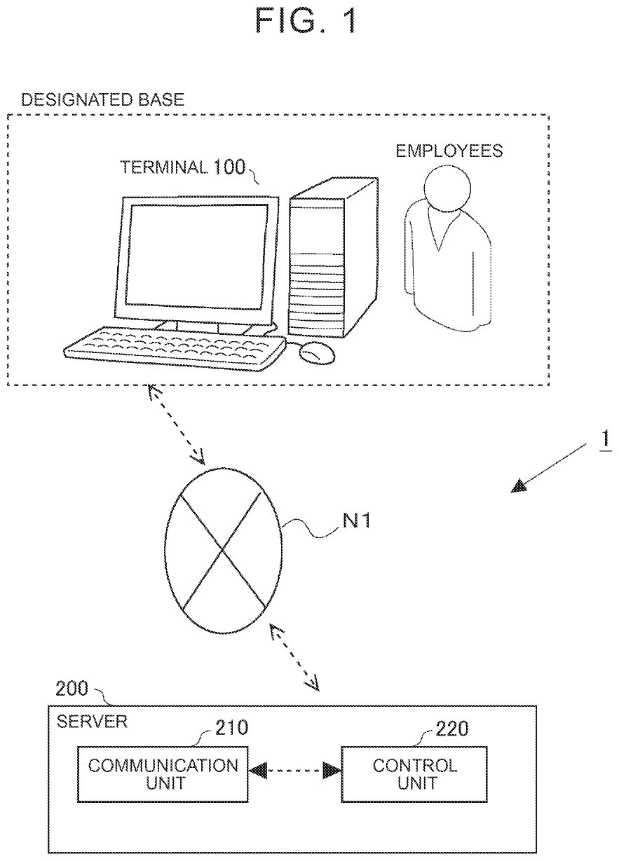

FIG. 1 is a block diagram schematically illustrating a configuration example of a system 1 according to the present embodiment. The system 1 according to the present embodiment provides a vehicle sales service and/or a lease service, and includes a terminal 100 and a server 200. In the example shown in FIG. 1, only one terminal 100 is shown, but a plurality of terminals 100 may be included in the system 1.

The terminal 100 is a terminal used at a predetermined base. The predetermined base is a store (for example, a car dealer or the like) or a maintenance factory or the like operated by a business operator that provides a sales service and/or a lease service of a vehicle. The terminal 100 is, for example, a computer on which a browser application program is installed, such as a smartphone, a mobile phone, a tablet terminal, a wearable device, or a personal computer. In the present embodiment, in a predetermined base, an employee or the like can access the server 200 through the terminal 100 to receive support information. The support information is information that supports a proposal made by an employee or the like to a user who visits a predetermined base. The “proposal” in the present embodiment includes a proposal related to a transfer time of the vehicle.

In the present embodiment, the vehicle currently used by the user is referred to as a first vehicle, and the vehicle that the user desires to transfer from the first vehicle is referred to as a second vehicle. It is assumed that the user purchases the first vehicle by installment. The second vehicle may be a vehicle to be sold or a vehicle to be leased. Further, the second vehicle may be a new vehicle or a used vehicle.

Next, the server 200 is an information processing device operated by a company (for example, a manufacturer of a vehicle, a related company of a manufacturer, or the like) that entrusts the sales business and/or the leasing business of the vehicle to a business operator at a predetermined base. The server 200 can be configured as a computer having processors, such as CPU or GPU, main storage devices, such as RAM and ROM, and secondary storage devices, such as EPROM, hard disk drives, or removable media. The secondary storage device of the server 200 stores an operating system (OS), various programs, various tables, and the like. The processor of the server 200 loads a program stored in the auxiliary storage device into a work area of the main storage device and executes the program, thereby realizing each function that matches a predetermined purpose, as will be described later. However, some or all of the functions of the server 200 may be realized by hardware circuitry such as Application Specific Integrated Circuit (ASIC) or Field Programmable Gate Array (FPGA).

The server 200 in the present embodiment is configured to be capable of implementing a Web server for interacting with the terminal 100. The server 200 interacts with the terminal 100 through executing Web server to provide the support information to an employee or the like at a predetermined base. Note that the server 200 may provide the above-described services by means other than Web server. For example, a service that interacts with dedicated application software installed in the terminal 100 according to a predetermined protocol may be executed in the server 200.

As illustrated in FIG. 1, the server 200 that realizes the above-described functions includes a communication unit 210 and a control unit 220.

The communication unit 210 is a communication interface for connecting the server 200 to a network N1. The communication unit 210 connects to a network N1 through, for example, a LAN or Wi-Fi (registered trademark), and communicates with the terminal 100 through a network N1. The network N1 is, for example, a WAN or another communication network that is a global public communication network such as the Internet.

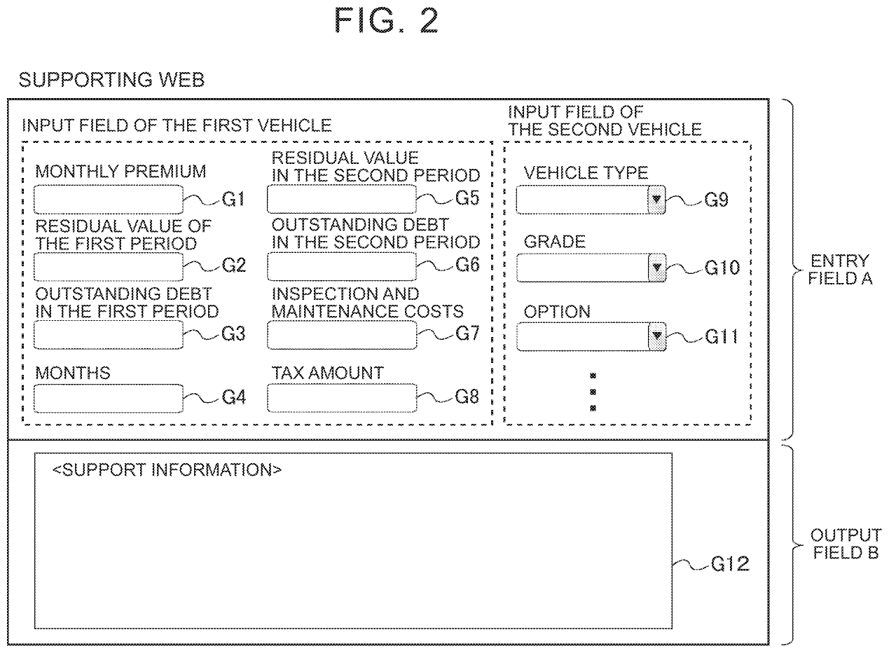

The control unit 220 is a software module realized by the processor of the server 200 executing a program stored in the auxiliary storage device. The control unit 220 interacts with the terminal 100 through executing Web servers. In the present embodiment, the control unit 220 displays a supporting Web page on the browser of the terminal 100. FIG. 2 is a diagram illustrating a first example of a supporting Web page. As illustrated in FIG. 2, the supporting Web includes an input field A and an output field B.

The input field A is a field for inputting information related to the transfer of the user, and includes an input field of information related to the first vehicle and an input field of information related to the second vehicle. The input field of information related to the first vehicle includes the following input items.
(Input-item 1) Monthly premium of the first vehicles (GUI part G1 in FIG. 2)
(Input-item 2) The residual price (GUI part G2 in FIG. 2) of the first vehicles in a first time
(Input-item 3) The remaining debt of the first vehicles in a first time (GUI part G3 in FIG. 2)
(4) Number of months from the first time to the second time (GUI part G4 in FIG. 2)
(Input-item 5) The residual price (GUI part G5 in FIG. 2) of the first vehicles in a second time
(Input-item 6) The remaining debt of the first vehicles in a second time (GUI part G6 in FIG. 2)
(Entry 7) Inspection and maintenance expenses (GUI part G7 in FIG. 2)
(Input item 8) Tax amount (GUI part G8 in FIG. 2)

Here, the first timing is a timing when the trade-in price of the first vehicle (the second amount described later) exceeds the remaining debt of the first vehicle. In one example, the first time period may be a time period in which the trade-in price of the first vehicle exceeds the remaining debt of the first vehicle (hereinafter, sometimes referred to as a “transfer recommended time period”), when the user visits a predetermined base for inspection, maintenance, repair, or the like of the first vehicle. Whether or not the time when the user of the first vehicle visits the predetermined base is within the transfer recommendation period may be determined by an employee or the like of the predetermined base. Further, the transfer recommendation period may be held in a database or the like connected to the secondary storage device of the server 200 or the server 200 through a network N1 in a form associated with information (for example, vehicle ID such as a vehicle body number) specifying the first vehicle. In this case, the control unit 220 of the server 200 may be configured to be executable to receive, through the web browser of the terminal 100, the entry of the vehicle ID by the employee or the like of the predetermined base, acquire the transfer recommendation period by accessing the auxiliary storage device or the database using the received vehicle ID as an argument, and present the acquired transfer recommendation period to the employee or the like of the predetermined base through the web browser of the terminal 100.

The second time period is a time period in the future from the first time period, and is a time period in which the user of the first vehicle easily considers the transfer. As the user of the first vehicle is easy to study the crossing over, the year and month of the next inspection of the first vehicle, the year and month of the next inspection of the first vehicle, and the first vehicle allocation contract is terminated (the year and month when the refund of the borrowing at the time of purchase of the first vehicle is completed), etc. can be exemplified. Note that the time when the user of the first vehicle easily considers the transfer is not limited to the above-described example, and may be appropriately changed according to the time when the user of the first vehicle has transferred to the past, the time when a plurality of users other than the user of the first vehicle have transferred to the past, and the like.

The remaining value of the first vehicle at the first time and the remaining value of the first vehicle at the second time are set based on the valuation in the market. In one example, the vehicle type, the grade, the body color, the year equation, and the like may be set to be equal to an actual evaluation value in the market for the same vehicle as the first vehicle. Here, the “market” is, for example, a market for used cars. Further, the remaining bond of the first vehicle is the remaining amount of the current outstanding borrowing of the borrowing at the time of purchase of the first vehicle.

The “vehicle inspection and maintenance cost” of the input item 7 is a cost for maintenance (for example, statutory inspection and vehicle inspection and maintenance) that the first vehicle needs to receive when it is assumed that the user continues to use the first vehicle in a period from the first time to the second time. The “tax amount” of the input item 8 is the amount of tax (automobile tax, automobile weight tax, and the like) imposed on the first vehicle during the period from the first time period to the second time period. The combination of the inspection and maintenance cost and the tax amount is an example of a predetermined cost according to the present disclosure.

The input field of the information related to the second vehicle includes the following input items.
(Entry 9) The vehicle type of the second vehicles (GUI part G9 in FIG. 2)
(Entry 10) Grading of the second vehicle (GUI part G10 in FIG. 2)
(Entry 11) Second Vehicle Options (GUI Component G11 in FIG. 2)

Note that the configuration of the input field of the information regarding the second vehicle is not limited to the example illustrated in FIG. 2, and changes, additions, and omissions of items may be made as appropriate according to the embodiment. For example, in a case where the second vehicle is a vehicle subject to lease, an item for inputting the type of the lease contract (for example, a contract that can be cancelled without cancellation money (return of the second vehicle) in the middle of the lease contract period, or a contract in which the cancellation money is generated when the vehicle is cancelled in the middle of the lease contract period) may be added.

Next, the output field B is a field for outputting support information corresponding to the input contents of the input items 1 to 11, and includes the following output items.
(Output 1) Supported data (G12 of GUI components in FIG. 2)

The support information includes information for comparing the payment amount (first payment amount) when the vehicle is assumed to be transferred from the first vehicle to the second vehicle at the first time and the payment amount (second payment amount) when the vehicle is assumed to be transferred from the first vehicle to the second vehicle at the second time. Note that, until the input of the input item 1 to 11 in the input field A is completed, the output item 1 in the output field B becomes blank as shown in FIG. 2.

When an employee of a predetermined base or the like inputs information to each of the input items 1 to 11 on the supporting Web page, the control unit 220 generates support information to be output to the output item 1. Specifically, first, the control unit 220 calculates the first payment amount on the basis of information input to the input item 1 (G1 in FIG. 2), the input item 2 (G2 in FIG. 2), the input item 3 (G3 in FIG. 2), the input item 7 (G7 in FIG. 2), and the input item 8 (G8 in FIG. 2). In an example, the control unit 220 calculates the first payment amount according to the following procedure.
(Procedure 1) The monthly insurance premium input into the input item 1 is multiplied by the number of months input into the input item 4, and the first amount of money is calculated
(Procedure 2) The tax amount input into the inspection and inspection expenses and the input item 8 which were input into the first amount of money and the input item 7 is added to the residual price (residual price of the first vehicles in a first time) input into the input item 2, and the second amount of money is calculated
(Procedure 3) From the second amount of money, the balance bond (balance bond of the first vehicles in a first time) input into the input item 3 is subtracted, and the 3rd amount of money is calculated
(Procedure 4) From the amount of payment about a second vehicles, the 3rd amount of money is subtracted, and the first amount of payment is calculated

The payment amount for the second vehicle is derived in accordance with the information input in the input item 9, the input item 10, and the input item 11. In this case, the information associating the vehicle type, the grade, the option, and the payment amount of the second vehicle may be stored in the secondary storage device of the server 200 or a database connected to the server 200 through a network N1. Then, the control unit 220 of the server 200 may derive the payment amount for the second vehicle by accessing the auxiliary storage device or the database using the information input to the input item 9, the input item 10, and the input item 11 as arguments.

Next, the control unit 220 calculates the second payment amount based on the information input in the input item 5 (G5 in FIG. 2) and the input item 6 (G6 in FIG. 2). In an example, the control unit 220 calculates the second payment amount according to the following procedure.
(Procedure 5) From the residual value (residual value of the first vehicles in a second time) input into the input item 5, the residual bond (residual bond of the first vehicles in a second time) input into the input item 6 is subtracted, and the 4th amount of money is calculated
(Procedure 6) The 4th amount of money is subtracted from the amount of payment about a second vehicles, and the second amount of payment is calculated

The control unit 220 generates the support information in accordance with the first payment amount and the second payment amount calculated in the above-described steps 1 to 6. In one example, the support information may include a first payment amount, a second payment amount, a difference between the first payment amount and the second payment amount, and the like. In the case where the second vehicle is a vehicle to be leased, the support information may include the number of months in which the monthly usage fee of the lease becomes free by appropriating the third amount, and the number of months in which the monthly usage fee of the lease becomes free by appropriating the fourth amount.

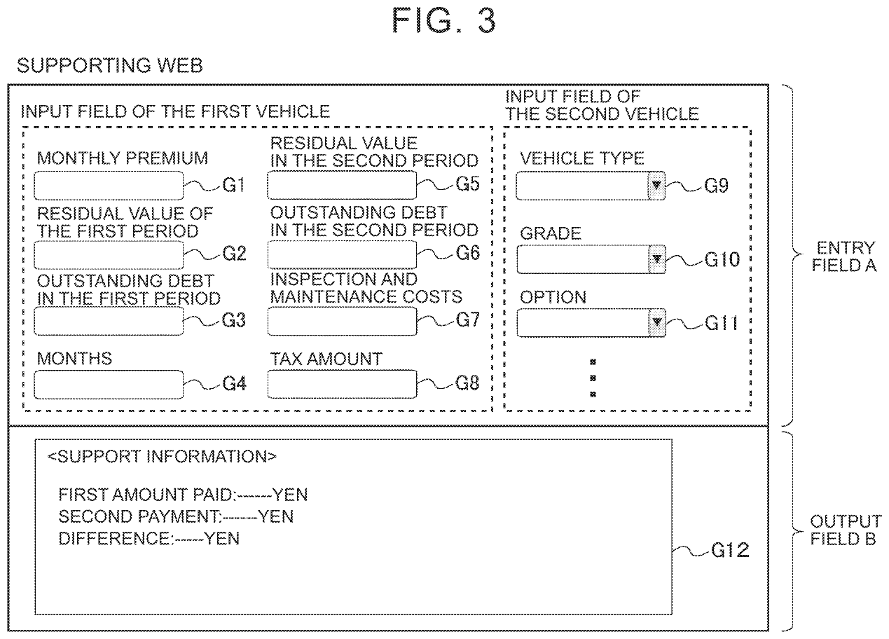

When the support information displayed in the output field B is generated in the above-described manner, the control unit 220 causes the generated support information to be displayed in the output item 1 (G12 in FIG. 3) of the output field B, as illustrated in FIG. 3. As a result, the business operator can appeal to the user of the first vehicle the financial merit of switching from the first vehicle to the second vehicle at the first time by looking at the support information displayed in the output field B of Web page for support as shown in FIG. 3. Therefore, the user can be motivated to switch from the first vehicle to the second vehicle at the first time.

Note that the configuration of the supporting Web is not limited to that shown in FIGS. 2 and 3, and the input-item and the output-item can be flexibly changed according to the embodiment. As an example, the input field A may be configured to include an input item for inputting the year and month of the first time and an input item for inputting the year and month of the second time, instead of the input item 4. In this case, the “number of months from the first time to the second time” used in the above-described calculation of (Step 1) may be calculated by the control unit 220 in accordance with the year/month of the first time and the year/month of the second time. In addition, the input-field A and the output-field B do not need to be displayed on the same Web page, but may be displayed on separate Web pages.

### Processing Flow

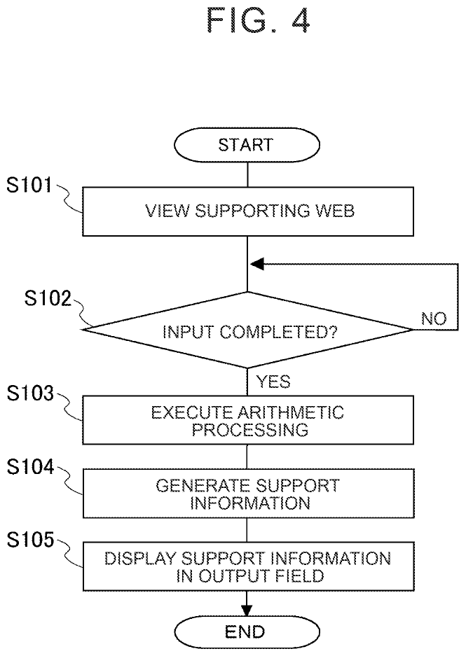

A processing flow executed by the server 200 according to the present embodiment will be described with reference to FIG. 4. FIG. 4 is a flow chart showing a process routine executed by the server 200 triggered by the operator accessing URL of the supporting Web page through the web browser of the terminal 100. The execution subject of the processing routine of FIG. 4 is the processor of the server 200, and the software module of the server 200 is described as the execution subject.

When the operator accesses URL of the support Web page through the web browser of the terminal 100, the control unit 220 of the server 200 causes the web browser of the terminal 100 to display a support Web page (see FIG. 2) in which the output field B is blank (S101). Upon completion of S101 process, the control unit 220 executes S102 process.

In S102, the control unit 220 determines whether the input of the input items 1 to 11 in the input field A of the supporting Web page has been completed. When the input of the input item 1 to 11 is not completed (negative determination in S102), the control unit 220 waits until the input of the input item 1 to 11 is completed. When the input of the input items 1 to 11 is completed (affirmative determination is made by S102), the control unit 220 executes S103 process.

In S103, the control unit 220 calculates the first payment amount and the second payment amount. The calculation of the first payment amount and the second payment amount is performed according to the following procedure 1 to 6, as described above.
(Procedure 1) The monthly insurance premium input into the input item 1 is multiplied by the number of months input into the input item 4, and the first amount of money is calculated
(Procedure 2) A 2 amount of money (corresponding to the trade-in price of the 1 vehicle) is calculated by adding the 1 amount of money, the inspection cost input to the input item 7, and the tax amount input to the input item 8 to the residual value (the residual value of the 1 vehicle at the 1 time) input to the input item 2.
(Procedure 3) From the second amount of money, the balance bond (balance bond of the first vehicles in a first time) input into the input item 3 is subtracted, and the 3rd amount of money is calculated
(Procedure 4) From the amount of payment about a second vehicles, the 3rd amount of money is subtracted, and the first amount of payment is calculated
(Procedure 5) From the residual value (residual value of the first vehicles in a second time) input into the input item 5, the residual bond (residual bond of the first vehicles in a second time) input into the input item 6 is subtracted, and the 4th amount of money is calculated
(Procedure 6) The 4th amount of money is subtracted from the amount of payment about a second vehicles, and the second amount of payment is calculated

Upon completion of S103 process, the control unit 220 executes S104 process. In S104, the support-information displayed in the output item 1 of the output field B is generated. In an example, the control unit 220 generates, as support information, information including a first payment amount, a second payment amount, and a difference between the first payment amount and the second payment amount. In the case where the second vehicle is a vehicle to be leased, the control unit 220 may generate, as the support information, information including the number of months in which the monthly usage fee of the lease becomes free by appropriating the third amount and the number of months in which the monthly usage fee of the lease becomes free by appropriating the fourth amount. Upon completion of S104 process, the control unit 220 executes S105 process.

In S105, the control unit 220 causes the support Web page (see FIG. 3) in which the support information generated by S104 is displayed in the output item 1 of the output field B to be displayed through the web browser of the terminal 100. When S105 processing is finished, the control unit 220 ends the execution of this processing routine.

### Operation and Effect of Embodiments

In the above-described embodiment, when the user of the first vehicle visits a predetermined base during the transfer recommendation period, the employee or the like at the predetermined base can receive the presentation of the support information by accessing the server 200 through the web browser of the terminal 100. As a result, the employee or the like at the predetermined base can appeal to the user that the transfer at the first time is less monetary than the transfer at the second time on the basis of the support information presented from the server 200. As a result, the user can be motivated to switch to the first time. Therefore, it is possible to promote the transfer of the vehicle by the user.

In the present embodiment, the server 200 corresponds to an “information processing device” according to the present disclosure. The control unit 220 of the server 200 corresponds to a “control unit” according to the present disclosure. Further, the supporting Web page according to the present disclosure corresponds to the “interface screen” according to the present disclosure.

### Other Embodiments

The above-described embodiment is merely an example, and the present disclosure can be appropriately modified and implemented without departing from the gist thereof. For example, processing performed by the server 200 may be performed by the terminal 100. That is, the terminal 100 may perform output of the interface screen including the input field A and the output field B, calculation of the first payment amount, calculation of the second payment amount, and generation of the support information through execution of the dedicated application program. In this case, the terminal 100 corresponds to an “information processing device” according to the present disclosure. Further, the processor of the terminal 100 executes a dedicated application program to achieve the “control unit” according to the present disclosure.

Also, the processes and the configurations described in the present disclosure can be appropriately combined to be implemented as long as no technical contradiction occurs. Moreover, the processes described as being executed by one device may be shared and executed by a plurality of devices. Alternatively, the processes described as being executed by different devices may be executed by one device. In the computer system, it is possible to flexibly change the hardware configuration for implementing each function.

What is claimed is:

1. An information processing device comprising a control unit configured to execute:
receiving input of information including a residual value of a first vehicle used by a user at a first timing, a residual value of the first vehicle at a future second timing that is later than the first timing, a predetermined cost to be incurred when it is assumed that the first vehicle is continuously used from the first timing to the second timing, a remaining loan balance for the first vehicle at the first timing, a remaining loan balance for the first vehicle at the second timing, a monthly insurance premium for the first vehicle, and a vehicle type of a second vehicle with which the user wishes to replace his/her vehicle;
calculating, in response to the receiving of the input, a first payment amount to be paid when it is assumed that the first vehicle is replaced with the second vehicle at the first timing and a second payment amount to be paid when it is assumed that the first vehicle is replaced with the second vehicle at the second timing; and
outputting information on a comparison between the first payment amount and the second payment amount.

2. The information processing device according to claim 1, wherein:
the calculating of the first payment amount includes
calculating a first amount of money by multiplying a number of months from the first timing to the second timing by the monthly insurance premium for the first vehicle,
calculating a second amount of money by adding the first amount and the predetermined cost to the residual value of the first vehicle at the first timing,
calculating a third amount of money by subtracting the remaining loan balance for the first vehicle at the first timing from the second amount of money, and
calculating the first payment amount by subtracting the third amount of money from a payment amount for the second vehicle; and
the calculating of the second payment amount includes
calculating a fourth amount of money by subtracting the remaining loan balance for the first vehicle at the second timing from the residual value of the first vehicle at the second timing, and
calculating the second payment amount by subtracting the fourth amount of money from the payment amount for the second vehicle.

3. The information processing device according to claim 1, wherein the outputting of the information on the comparison between the first payment amount and the second payment amount includes outputting a user interface screen that includes the first payment amount, the second payment amount, and a difference between the first payment amount and the second payment amount.

4. The information processing device according to claim 1, wherein the receiving of the input includes outputting a user interface screen that includes an input field for the residual value of the first vehicle at the first timing, an input field for the residual value of the first vehicle at the second timing, an input field for the predetermined cost, an input field for the remaining loan balance for the first vehicle at the first timing, an input field for the remaining loan balance for the first vehicle at the second timing, an input field for the monthly insurance premium for the first vehicle, and an input field for the vehicle type of the second vehicle.

5. The information processing device according to claim 1, wherein the first timing is a timing when a second amount of money exceeds the remaining loan balance for the first vehicle.
